(19) United States
(12) Patent Application Publication
(10) Pub. No.: US 2002/0042290 A1
(43) Pub. Date: Apr. 11, 2002

(54) Method and apparatus employing a remote wireless repeater for calibrating a wireless base station having an adaptive antenna array

(76) Inventors: Terry L. Williams, Melbourne, FL (US); Thomas R. Schmutz, Indialantic, FL (US); John R. Noll, Palm Bay, FL (US)

Correspondence Address: Akerman, Senterfitt & Eidson, P.A., Post Office Box 3188, West Palm Beach, FL, 33402-3188, US

(21) Appl. No.: 09/975,206

(22) Filed: Oct. 11, 2001

Related U.S. Application Data
(60) Provisional application No. 60/239,859, filed on Oct. 11, 2000.

(51) Int. Cl. H04M 1/00

(52) U.S. Cl. 455/562; 455/424; 455/67.4

(57) ABSTRACT

A method and apparatus for calibration of an adaptive antenna array in a wireless communication system having at least one remote device for communicating with a base transceiver station (BTS) and a plurality of mobile stations can determine calibration factors for respective antenna transmit and receive paths without the need for any additional or external equipment for calibration. Calibration factors for respective transmit and receive paths associated with each of the antenna elements are determined by transmitting a downlink signal from the BTS to the remote device from each of the antenna elements, retransmitting from the remote device the downlink signals back to the BTS as at least one uplink signal, and receiving the uplink signal at the BTS.

### CROSS REFERENCE TO RELATED APPLICATIONS

This application claims the benefit of U.S. Provisional Application No. 60/239,859 entitled, “ADAPTIVE ANTENNA ARRAY CALIBRATION SYSTEM AND METHOD,” filed Oct. 11, 2000, the entirety of which is incorporated herein by reference.

### STATEMENT REGARDING FEDERALLY SPONSORED RESEARCH OR DEVELOPMENT

(Not Applicable)

### BACKGROUND OF THE INVENTION

1. Field of the Invention

This invention relates to the field of RF communication systems, and more particularly to a system and method for calibration of adaptive antenna arrays.

2. Description of the Related Art

In order to remain competitive in an increasingly crowded market, wireless equipment manufacturers experience constant pressure to reduce their costs and improve performance. One way to reduce the overall cost of a cellular phone system is to redesign individual system components or software so that the system may operate more efficiently. For example, it would be desirable to supply more users while maintaining an acceptable signal quality. One method for increasing the efficiency and performance of a cellular system is through the use of adaptive antenna arrays (“adaptive arrays”). Until recently, adaptive arrays had been used almost exclusively for a variety of military applications, such as phased-array radar and direction-finding systems. Non-military uses were limited by losses and signal degradation resulting from the combining of a large number of analog signals (in transmit mode) and splitting the large number of analog signals (in receive mode) required in multi-channel communication systems. The losses and degradation noted was generally more than offset by any advantage gained through employing an adaptive antenna array. However, with the advent of high-speed digital signal processing, losses and signal degradation associated with analog processing to accomplish the same result are almost entirely avoided.

Adaptive antenna array systems provide greater range over traditional technologies due to increased antenna gain. As a carrier wave propagates through space, the signal power decreases. Since mobile subscribers cannot detect signals below a minimum threshold level of power, increasing antenna gain extends the distance a carrier wave can travel. Thus, an adaptive antenna array can increase the cell size that a given base transceiver station (BTS) can serve.

An adaptive antenna array can also increase user capacity over traditional antenna technology by amplifying the signal coming from and going to the mobile user while dampening other signals coming from sources disposed in other directions. This ability is commonly referred to as “digital beamforming.” By steering a beam and positioning multiple nulls, an adaptive array is able to reduce co-channel and adjacent channel interference. This allows each cell to use all frequencies within an operator's licensed band and may even make it possible to use single carrier frequencies more than once within a given cell. Separating multiple signals having the same frequency is possible using an adaptive array, provided the signals arrive from angles or otherwise have distinctive propagation paths. In the same manner, multipath arrivals of a desired signal, which in typical systems degrades signal quality due to intersymbol interference, is used to define the spatial signature, thus isolating and enhancing the signal from interferers.

An antenna array consists of N identical antenna elements arranged in a particular geometry. The geometry of the array determines spatial resolution of the signals transmitted or received, i.e. the amount of coverage in a given spatial region. Commonly used array types are the uniform linear and circular arrays.

For any given geometry, the phases and amplitudes of the currents exciting the array elements as well as the number of array elements determine the gain of the array in a certain direction. The phases and amplitudes of the currents on the antenna array elements can be electronically adjusted such that received signals from a certain direction add in phase, and maximum gain is achieved in that direction. Due to the reciprocal nature of adaptive antennas, this approach is also generally applicable to focus the direction of transmitted energy from the antenna array for transmission as well.

To adjust the amplitude and phases of the individual array currents, complex weights are placed in the signal path of each antenna element. The weighted signals are combined and the output is fed to a control unit that operates on the individual signals and their combined output to update the weights. Weight updating is usually accomplished adaptively to satisfy a chosen optimization criteria.

There are several commonly used adaptive algorithms available for updating the weights. These include gradient based algorithms, recursive methods, and others such as the constant modulus method (CMA).

For the phases and amplitudes of the various currents of the antenna array transmit elements to be controlled properly, the individual (unweighted) array currents must be emitted by the various antenna elements at the same instant with a known phase and amplitude. Consequently, the relative phase and amplitude offsets introduced for each of the complete transmit paths associated with each array element must be determined and compensated for to provide precise beam steering. Since the direction from the base station for transmitting a beam is determined partly from information provided by the receive signal, relative phase and amplitude offsets in each of the complete receive paths associated with each array element must also be determined in order to understand the effect of the receive signal path providing angle-of-arrival information. In digital systems, the complete transmit and receive paths extend between the respective digital signal processors and the respective antenna elements.

Each adaptive array antenna element requires a separate transceiver chain for operation of the adaptive array. Thus, each antenna element is provided a dedicated receiver apparatus chain and transmit apparatus chain. For example, a receive apparatus chain may include an antenna element, cables, filters, RF electronics, physical connections, and an analog-to-digital converter, assuming the processing is digital. Due to normal variances in the manufacture of the antenna array elements, connecting cables, and transmit and receive electronics chains, there will be differing errors and non-linearities introduced by signal paths comprising combinations of these components. Thus, for example, identical signals for transmission passing through the different transmit apparatus chains will emerge with different amplitudes and phases.

These composite amplitude and phase errors in a given antenna signal path can be captured for a fixed reference angle from the base station (for example, north) and a set of receive and transmit calibration factors calculated to equalize the transfer functions of the various receive and transmit apparatus chains. Each antenna array element along with its corresponding cables and the corresponding receive electronics in the path from each antenna element to its respective digital signal processor shall be referred to as the “receive apparatus chain” for each antenna element. Similarly, each antenna array element along with its corresponding cables and the corresponding transmit electronics from the respective digital signal processor to the respective antenna element shall be referred to as the “transmit apparatus chain” for each antenna element. These calibration factors can be used to transmute the actual signals that are actually seen at the end of each antenna array element chain into corresponding signals that would be expected at the end of each chain if all signal path components behaved identically.

Because the transmit signals and the receive signals follow somewhat different hardware paths, the adaptive antenna system will have both transmit and a receive calibration factors. It should also be noted that the phase and amplitude shifts that occur in the receive and transmit apparatus chains are, in general, frequency dependent. Thus, in broadband applications, calibration factors must generally be determined at the plurality of carrier frequencies used, or at least a sampling of these frequencies.

Accurate real-time calibration is required for all receive and transmit apparatus chains. Periodically, the calibration procedure must be performed as differences in the propagation path may vary during the day and from day to day due to temperature and other environmental conditions. Since there are active components involved, their responses will generally change with time and temperature. Thus, for an adaptive antenna array to function properly, periodic calibration of the various transmit and receive apparatus chains should be performed.

The complete paths for the receive apparatus chains may be calibrated using a fixed near-field or far-field transmitter calibration source to allow the respective receive apparatus chain path delays and magnitude shifts to be calculated and stored. The calibration of the transmit apparatus chain path delays, phase and magnitude shifts is similar, requiring signals to be transmitted simultaneously from each antenna array element to be received at a known near-field or far-field reference point.

Therefore, there is a need for a method to calibrate all transmit apparatus chains and receive apparatus. Moreover, such a method should preferably not impact the traffic capacity of the cellular system.

### SUMMARY OF THE INVENTION

A method for determining calibration factors for respective transmit and receive paths associated with an adaptive antenna array having a plurality of antenna elements is accomplished. The system includes a base transceiver station (BTS) having an adaptive antenna array and at least one remote device for communicating with the BTS. Multiple downlink signals are transmitted from the BTS, preferably simultaneously, to the remote device, one signal from each of the antenna elements. The remote device retransmits the downlink signals back to the BTS, preferably as one composite uplink signal. The returned composite uplink signal contains information for each of the receive and transmit antenna array paths that is uniquely discernable. BTS then determines calibration factors for the respective antenna transmit and receive paths.

The remote device can be a repeater, preferably a translating repeater. The translating repeater can demodulate downlink calibration signals. The method can further include the step of placing the remote device in a loopback mode. The method can also include the step of storing the determined calibration factors.

The BTS can transmit the downlink signals one at a time. Alternatively, downlink signals can be transmitted by the BTS from respective antenna elements at substantially the same time.

The method can include the step of programming the remote device with a list of calibration frequencies. Alternatively, the method can include the step of the BTS providing a list of calibration frequencies to the remote device using a wireless transmission. For example, the list of calibration frequencies can be transmitted by the BTS along with neighbor list and system information.

Calibration can be performed so as to not impact system traffic capacity. For example, when the communication system is a TDM system, a RACH signal can be used for the uplink signals and a SDCCH for the downlink signals.

Calibration can be performed at a plurality of carrier frequencies. In this embodiment, the method can include the step of the BTS commanding the remote device to a frequency other than the first calibration frequency.

A self-calibrating communications system not requiring any additional or external equipment for calibration includes a base transceiver station (BTS) having an antenna array with a plurality of antenna elements and at least one remote device for communicating with a plurality of mobile stations and the BTS. The remote device is adapted to be configured in a loopback mode, wherein calibration signals transmitted by the BTS are retransmitted by the remote device back to the BTS during calibration. Thus, antenna array calibration factors for the respective antenna transmit and receive paths can be determined without the need for any other additional or external equipment for calibration.

The remote device can be a repeater, preferably a translating repeater. The remote device can include a structure for demodulating the calibration transmitted by the BTS.

### BRIEF DESCRIPTION OF THE DRAWINGS

There are presently shown in the drawings embodiments which are presently preferred, it being understood, however, that the invention is not limited to the precise arrangements and instrumentalities shown.

FIG. 1 shows a simplified block diagram of a wideband digital beamforming base station transceiver (BTS).

FIG. 2 shows a block diagram of a wireless communications system deploying a plurality of wireless translating repeaters and base transceiver stations.

FIG. 3 shows the various components comprising the total signal shift for the round trip of a loopback signal transmitted by a base transceiver station (BTS) to a remote device and back to the BTS.

FIG. 4 is a flow chart for a calibration method according to an embodiment of the invention.

### DETAILED DESCRIPTION OF THE INVENTION

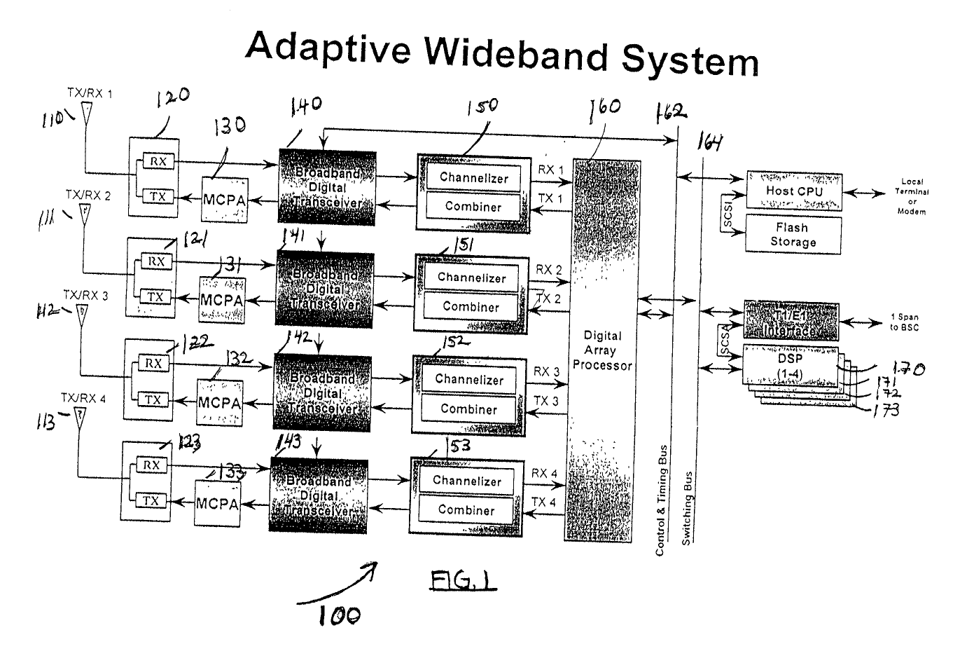

Referring to FIG. 1, a simplified block diagram of a digital beamforming base transceiver station (BTS) is shown. BTS 100 shown includes a 4 element antenna array 110-113 (hereafter 110). Although a 4 element array is shown, BTS 100 can have any number of antenna elements provided at least two elements are provided.

Each antenna element has a dedicated receive apparatus chain comprising filter/duplexer 120-123 (hereafter 120), broadband digital transceiver 140-143 (hereafter 140), channelizer/combiner 150-153 (hereafter XMUX 150) and associated connectors inclusive of digital signal processors 170-173 (hereafter 170). In the receive mode, XMUX 150 operates as a channelizer. In a broadband application, digital signal processor boards (DSP) 170 comprise a plurality of individual digital signal processors. Filter/duplexer 120 performs amplification, filtering and down conversion to IF of received RF signals. In broadband applications, assuming multiple frequency channels are active at any given instant, received signals are multi-channel signals.

The broadband digital transceiver 140 performs A/D conversion then digitally down-converts received signals. The multi-channel digital signal output by the broadband digital transceiver 140 is separated by channelizer 150 into baseband digital signals having an I and Q representation for each active channel. There is preferably one channelizer 150 provided for each antenna element 110. In the preferred embodiment, the channelizer 150 is a FFT channelizer. The baseband digital signals, respectively associated with each antenna element 110, can then communicated to a processor, such as digital array processor 160. Although shown as a separate module and positioned on the XMUX 150 side of control and timing bus 162 and switching bus 164, digital array processor 160 can be positioned on the other side of buses 162 and 164 with DSP 170. Moreover, in the preferred embodiment, digital array processor 160 can be positioned on the same board as DSP 170.

Digital array processor 160 can be used to store the various adaptive array calibration factors and angular weighting factors. Calibration factors and angular weighting factors are preferably stored separately. Calibration factors are used to compensate for relative path delay and amplitude variations that occur when signals traverse the various transmit and receive apparatus chains, with reference to a fixed reference angle (for example, north). The angular weighting factors are used to point the antenna beam and nulls into the desired directions (for both transmit and receive) relative to the reference angle (for example, +23 degrees north). The phases and amplitudes of the calibration factors and angular weighting factors are effectively added together to result in a net weighting factor that is applied to signals traveling in each antenna apparatus chain for each signal frequency (and time slot in TDM systems).

Digital array processor 160 may be used to calculate the various calibration factors and angular weighting factors and store these factors. Through application of net weighting factors to each of the respective apparatus chains, digital array processor 160 can adjust the baseband digital signals received from and for transmission by each antenna element 110 to beamform each active channel. The net weighting factors can be determined and applied using “Super DSP” cards, where one processor does the beamforming for a single RF carrier (all 8 time slots in GSM, for example) and a second processor does the signal processing (modem functions). Having both processors on the same board reduces signal interconnectivity requirements and improves system reliability. Combining the processors on a single board also generally reduces system cost compared to separate board implementations when implementing adaptive antenna arrays.

For the receive path, the respective phase and amplitude net weighting factors are preferably applied after the XMUX 150 (digital channelizer) and before the DSP 170. DSP 170 receives the signal components adjusted with respective net weighting factors from each receive apparatus chain output by the digital array processor 160 and demodulates these signals to recover the combined beamformed communication signal. The recovered communication signal is then communicated to the communication system via a suitable interface (not shown).

System operation in the transmit direction is quite similar to the receive direction. Each antenna element has a dedicated transmit apparatus chain comprising filter/duplexer 120, multi-carrier power amplifier (MCPA) 130-133 (hereafter 130), broadband digital transceiver 140-143, XMUX 150 (using the combiner) and associated connectors inclusive of respective digital signal processors 170. DSPs 170 are associated with specific antenna elements 110 and a specific frequency channel for processing respective ones of a plurality of incoming (voice/data) communication signals to be transmitted over respective frequency channels. Their processed (modulated and encoded) outputs are supplied to the digital array processor 160, which can apply appropriate net weighting factors to each active channel and for each transmit apparatus chain associated with each antenna element 110. For the transmit path, the phase and amplitude net weighting factors are preferably applied after the DSP 170 (modulation) and before the XMUX 150 (digital combiner). At these points in the signal path, each signal (RF frequency and time slot) is a baseband signal having an I and Q representation.

The outputs of the digital array processor 160 for each transmit apparatus chain are input into a combiner 150. In the preferred embodiment, there is one combiner 150 for each antenna element 110 and the combiner is an inverse FFT combiner. The combiner 150 forms a multichannel digital signal which is input to the broadband digital transceiver 140, where it is upconverted to IF, D/A converted, and amplified by a high power multi-carrier power amplifier (MCPA) 130. The composite multi-frequency signal is then supplied to RF elements 120 for amplification, filtering and up conversion from IF to RF. The antenna elements 110 then each transmit the beamformed multi-frequency communication signal.

Although a 4 element antenna array embodiment is shown in FIG. 1, the invention is not limited to 4 antenna elements. Note that although four DSP boards 170 are shown in FIG. 1, each may provide a plurality of digital signal processors per board. For example, 24 digital signal processors may be provided per DSP board 170. In the preferred embodiment of the invention, 96 channels are supported by BTS 100 through use of 12 RF carriers and 8 TDM time slots. A separate digital signal processor may be dedicated to each channel (timeslot), or a digital signal processor having sufficient processing speed may process multiple channels, such as all eight channels (timeslots) in GSM systems.

To obtain improved performance of the adaptive antenna array, both transmitted and received signals must be calibrated so that unweighted signals traveling along the various antenna apparatus chains from respective DSPs 170 to antenna element 110 each reach each antenna element 110 (transmit) and DSPs 170 (receive) simultaneously (phase) and with the same amplitude. Preferably, the various transmit and receive apparatus chains are calibrated to all be within 1 to 2 degrees of phase and 0.1 db to 0.2 db in magnitude relative to each other.

At the time of system installation, the physical distances between the various antenna elements are preferably measured and recorded. This information can be used to calculate and compensate for free space path time delays between the various antenna elements. For example, for a triangular 4 element system where a single antenna is placed at the center of the triangle, there are 4 unique distances to measure.

The invention uses a remote device to receive and loopback signals transmitted by BTS 100 to determine calibration factors for the various receive and transmit apparatus chains. In one embodiment of the invention, the remote device also frequency shifts the received calibration signal into the receive band of BTS 100. In the preferred embodiment of the invention, a remotely located wireless translating repeater (“translating repeater”) may be used as the remote device for calibration of an adaptive antenna array included with BTS 100.

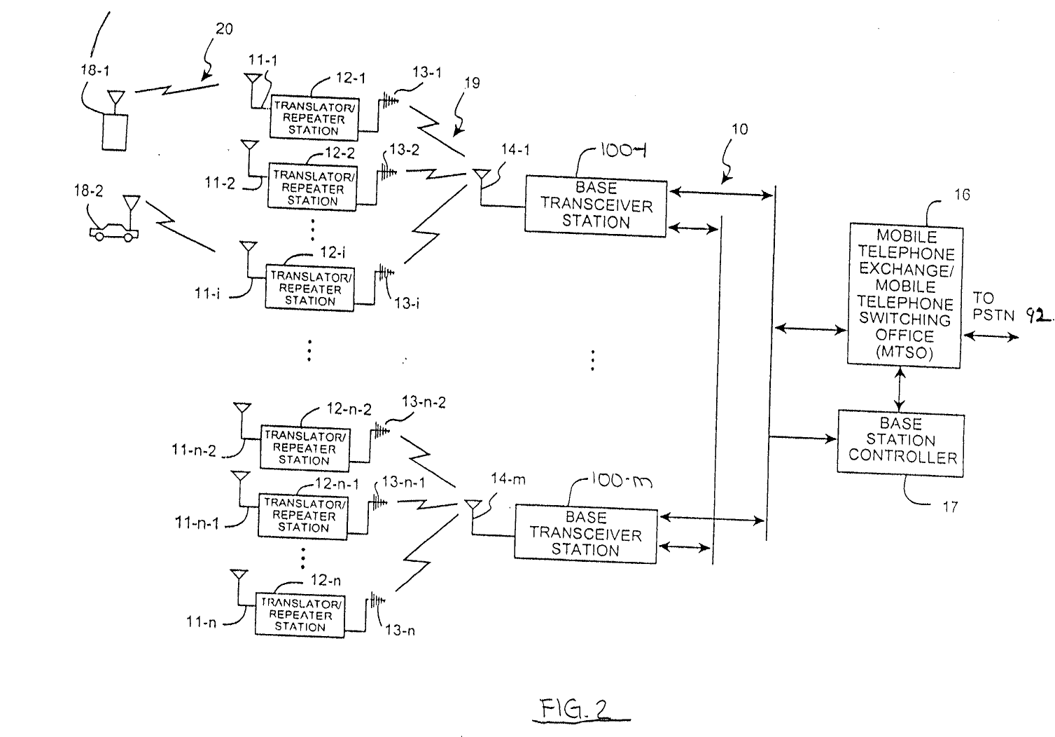

As shown in the block diagram illustrated in FIG. 2 a conventional wireless communications system such as a Personal Communication System (“PCS”) or other similar system 10 can include remote repeaters, such as translating repeaters. In this system 10, omni-directional translating repeaters 12-1 . . . 12-n are deployed in peripheral cells surrounding broadband base transceiver stations (“BTS”), such as 100-1 . . . 100-m. Clusters of cells are each supported by a plurality of translating repeaters, such as translating repeaters 12-1 . . . 12-i. Cell clusters are generally associated with a single BTS, such as 100-1. Translating repeaters within a cell cluster are generally exclusively served or hosted by a “host BTS” positioned within a given cell cluster.

Those skilled in the art will readily appreciate that non-translating repeaters or directional or sectorized translating repeaters may replace omni-directional translating repeaters 12-1 . . . 12-n in this system. The system 10 can include translator omni-directional antennas 11-1, 11-2 . . . 11-i, . . . 11-n-2, 11-n-1 and 11-n, translating repeaters 12-1, 12-2, . . . 12-i, . . . 12-n-2, 12-n-1 and 12-n, translating repeater antennas 13-1, 13-2, . . . 13-i, . . . 13-n-2, 13-n-1 and 13-n, BTS directional antennas 14-1, . . . 14-m, and broadband base transceiver stations 15-1, . . . 15-m. The system 10 can further include a mobile switching center (“MSC” ) 16, one or more base station controllers 17 and a plurality of mobile users 18-1 and 18-2.

Translating repeaters 12 receive radio signals from mobile users 18 through omni-directional antennas 11 and forward a frequency shifted version of the received signal to BTS 100 through translating repeater directional antennas 13. Likewise, radio signals transmitted from BTS 100re frequency shifted by translating repeater 12 before being forwarded to mobile users 18. BTS 100 demodulates signal received from translating repeaters 12 through BTS antennas 14 and connects these signals to the Public Switched Telephone Network 92 (PSTN) through MSC 16. In addition, in the transmit direction, BTS 100 modulates signals received from the PSTN 92 through MSC 16 to format them for transmission through BTS antennas 14-1 . . . 14-m to their respective hosted translating repeaters 12.

Thus, in systems such as 10, a plurality of translating repeaters may already be installed in conjunction with one or more BTS 100. In this case, use of a translating repeaters as an adaptive array calibration device results in no added system expense. If a wireless translating repeater is not already used in the cellular system, a reduced cost modified translating repeater version can be used, the modified translating repeater having only backhaul receive and transmit functions.

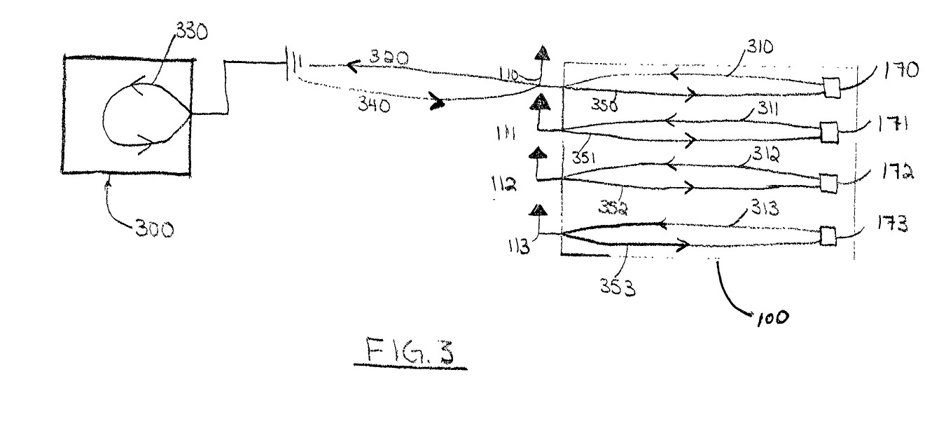

The total phase delay and magnitude shift (collectively the “signal shift”) for a round trip (TD) of a loopback signal transmitted by BTS 100 to a remote device 300, retransmitted by the remote device 300 and received by BTS 100 consists of the following components as shown in FIG. 3 for a n=4 element array:

1. Signal shift from the respective DSP 170-173 to respective transmit antenna elements 110-113 (transmit apparatus chain), shown as 310-313; plus

2. Delay during signal travel in free space to the remote device, shown as 320 for antenna element 210; plus

3. Signal shift during remote device signal shown as 330; plus

4. Delay during signal travel in free space from remote device 300 back to respective antenna elements, such as 340 for antenna element 210, (note that due to symmetry 320=340), plus

5. Signal shift from each receiving antenna 210-213 to their respective DSP 170 (receive apparatus chain), shown as 350-353. Thus, for the 4 element antenna array BTS 100 shown, 16 distinct round trip signal shifts can be measured from the various combinations of distinct possible round trip paths. Thus, 16 independent linear equations can be derived. During or soon after installation, the remote device 300 location is measured and characterized with reference to the fixed angular position and distance between the remote device 300 and the respective BTS antenna elements 210-213. This is normally accomplished using a survey. This fixed information can then be stored by BTS 100 and taken into account during calibration factor calculations to account for the differences in free space delays such as 320 and 340 between the remote device 300, such as a translating repeater, and the various antenna elements 210-213. Since the there are only 9 unknowns being 4 transmit apparatus chains 310-313, 1 unknown signal shift 330 at remote device 300 and 4 receive apparatus chain signal shifts 350-353, compilation of data for the respective round trip paths permits solution to the above-referenced unknowns.

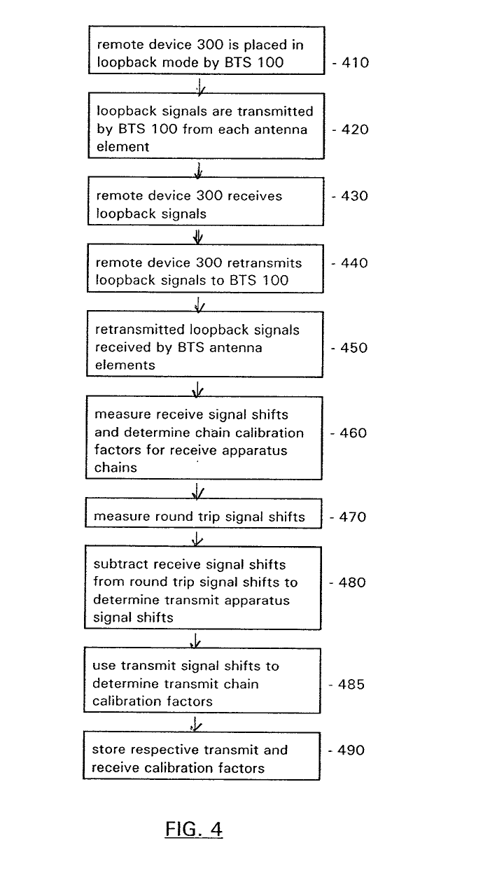

A first embodiment of the invention is described with the help of the flow chart of FIG. 4. In step 410, a remote device, such as a translating repeater, can be signaled to enter a loopback mode by an appropriate signal, preferably a wireless signal from BTS 100. In the loopback mode, the remote device 300 retransmits received signals received from the BTS 100 back to the BTS 100. For example, a translating repeater may be placed in the loopback mode for one frame (8 time slots in GSM). Once in the loopback mode, signals received by the translating repeater are preferably coupled off to a low level (e.g. −40 dB), additionally attenuated, and frequency shifted from the transmit to receive band (for example, 80 MHZ lower for GSM-1900) and then re-transmitted back to BTS 100.

In GSM systems, the BTS 100 transmitted loopback signal is preferably GSM type access burst, the burst being any burst having a short duration relative to the duration the applicable timeslot. In step 420, loopback signals can be transmitted from each BTS antenna element 210-213, one at a time. In step 430, the remote device (e.g. translating repeater) receives the loopback signals. In step 440, the remote device re-transmits the loopback signals to BTS 100. In step 450, the retransmitted loopback signals are received by any or all antenna elements 210-213 of the BTS adaptive array. In step 460, signal shifts for each receive apparatus chain 310-313 may be measured and calibration factors determined from resulting receive apparatus chain signal shifts 310-313 measured from receipt of any one of the returned loopback signals originally transmitted by BTS 100 from any of its antenna elements. These values may be recorded for each antenna receive chain to permit computation of calibration factors for the respective receive apparatus chains to compensate for receive signal shift differences.

Similarly, in step 470, round trip signal shifts (TD) for the loopback signals can be measured. For a 4 antenna element adaptive array, 16 round trip signal shifts can be measured. In step 480, transmit apparatus chain calibration factors 350-353 are readily be determined by subtracting the earlier determined respective receive signal shifts 310-313 from measured round trip signal shift data and adjusting for free space delay differences such as 320 and 340. Transmit apparatus chain calibration factors can be used to compensate for transmit signal shift differences from signals transmitted by each antenna element 210-213. In step 490, receive and transmit apparatus signal shifts are stored in a suitable BTS memory. Since signal shifts are generally frequency dependent, the calibration process for both transmit and receive apparatus chains are preferably repeated for at least a representative sample of all carrier frequencies supported by BTS 100.

In another embodiment of the invention, calibration factors can be determined over a range of frequencies using a farfield calibration method. At any given time, the transfer characteristics of the various transmit apparatus 310-313 and receive apparatus chains 350-353 can vary over the frequency band of broadband BTS 100. This is primarily due to the differences in the broadband transceiver's 240 SAW filter transfer characteristics from its band edges to the center of the filter's band. Frequency dependence of the calibration factors requires the various antenna paths to be analyzed at several frequencies across the broadband BTS frequency band.

This embodiment preferably uses a translating repeater with loopback capabilities as part of the calibration process. The repeater can be placed at (or utilized from) a known location with respect to a BTS having an adaptive antenna array. The BTS and translating repeater can each be programmed with a set of calibration frequencies.

After determining calibration factors at a first carrier frequency, the BTS 100 can signal the remote device, such as a translating repeater, to step to a next programmed calibration frequency. Likewise, the BTS 100 can step to the next calibration frequency and the calibration process can be repeated at one or more other carrier frequencies. Calibration information can then be saved for each carrier frequency and used to compensate for the differences in the transfer function of the various receive apparatus chains and transmit apparatus chains when a call is assigned having a given carrier frequency.

The above described multi-frequency calibration method required the remote device to be pre-programmed to operate at certain predetermined calibration frequencies for the calibration process to proceed. However, in a preferred embodiment of the invention, the BTS 100 can provide wireless calibration frequency information to the remote device 300, rather than relying on pre-programming. The ability to provide wireless calibration frequency information to the remote device allows the system in real-time to calibrate new BTS carrier frequencies within a cellular provider's allocated band which may be assigned during normal cellular system operation.

The remote device (e.g. calibration transceiver) may be co-located with a BTS 100 for near-filed calibration. Alternatively, the calibration transceiver can be actually used in the cellular system, such as a translating repeater while also supporting far-field calibration.

Preferably, frequency calibration information is provided without impacting the traffic capacity of the cellular system. For example, BTS 100 regularly transmits a “neighbor list” over a control channel that mobile users use to determine the frequencies to scan adjacent cells. Scanning the received signal strength (RSSI) of mobile users from transmissions originating from base stations serving neighboring cells is commonly used by cellular systems to perform mobile assisted handovers. The co-located calibration transceiver or remotely located translating repeater could also receive and use the calibration information provided by the BTS transmitting a calibration frequency listing along with the neighbor list information.

In addition, in some systems such as GSM, operator defined information that is not required for the operation of a conventional wireless system can be transmitted. In GSM, specific “System Information” supports this function. Information that is broadcast on the BCCH is broadcast in groups called “System Information.” There are currently 16 different System information messages that are currently defined in the GSM 04.08, Mobile layer 3 Interface Specification Standard. System information can also be used to broadcast to “intelligent” programmable calibration units the calibration frequencies to perform the antenna array calibration.

In a preferred embodiment of the invention, calibration of the various transmit and receive array chains may be performed in a manner which does not impact the traffic capacity of the cellular system. For example, idle time slots of frames normally allocated for Standalone Dedicated Control Channels (SDCCH) on the downlink and idle Random Access Channels (RACH) on the uplink may be used to calibrate a GSM BTS having an adaptive antenna array using a remote device, such as a translating repeater. The invention preferably uses a translating repeater with loopback capabilities as part of the calibration process.

A problem with using a translating repeater with loopback for adaptive array calibration is that two traffic channels, which may otherwise support cellular traffic, may be occupied during the calibration interval. In GSM systems, the uplink and downlink channels in TDM systems having 8 time slots (e.g. GSM) are offset by 3 time slots (time slots are also referred to as burst periods). In GSM, from the BTS perspective, the uplink burst follows the downlink burst by 3 time slots. Alternatively, from the mobile's perspective, the downlink follows the uplink by three time slots. For example, from the mobile's perspective, if the downlink burst uses time slot 6, the corresponding uplink burst uses time slot 3. Consequently, if traffic time slots are used for antenna array calibration, antenna array calibration using a translating repeater with loopback in a GSM system would generally require two traffic channels be allocated for the calibration.

Various options are conceivable to avoid using otherwise active traffic channels. The calibration method could wait until two appropriately spaced nontraffic time slots of a given carrier frequency become idle, but during busy times calibration could be significantly delayed. Such a delay could result in degraded beamforming performance due to adaptive array component drift.

A more efficient calibration method is to channels normally allocated for control purposes. For example, a burst otherwise allocated for SDCCH on a downlink control channel can be used for transmission of the BTS calibration signal and a RACH signal can be used for the translating repeater uplink calibration signal. Time slots during the selected specific frames of the multiframe used preferably align in time in the uplink and downlink direction.

SDCCH are stand-alone dedicated control channels included as part of the 51 frame control multiframe. When an SDCCH is configured on a time slot other than time slot 0, 8 SDCCHs are defined. When a mobile user accesses the cellular network using a RACH, the BTS 100 will assign the mobile user one of the 8 SDCCHs, unless the mobile is a GPRS mobile.

A GSM non-combined control carrier supports RACHs on the uplink on time slot 0 for all frames. Downlink SDCCH is specifically assigned to time slot 3 because the downlink SDCCH is desired to align in time with the uplink RACH which is fixed on time slot 0 in GSM systems. Time slot 0 is used exclusively for the uplink RACH. Other control channel configurations also allow the SDCCH to be multiplexed on time slot 0, but for purposes of this invention, this is not preferred because the downlink SDCCH would not align with the uplink RACH.

The last 3 frames of the 51 frame control multiframe configured to support SDCCHs are generally not used as they are intentionally left idle in GSM systems. Accordingly, in GSM systems, calibration signals can be transmitted by the BTS 100 during these idle frames, which are preferably assigned to time slot 3. This permits the translating repeater to transmit the frequency shifted calibration signal on time slot 0 normally allocated to a RACH, stealing the RACH. Thus, the calibration is performed without utilizing time slots which can otherwise be used to support traffic.

The calibration signal cannot overlap into an adjacent time slot without being corrupted. Thus, the calibration signal should propagate from BTS 100 to the remote calibration unit and return so that the returned calibration signal does not overlap with an adjacent (later) timeslot. Therefore, it is preferable to use a short duration burst, such as a burst having the length of a RACH, because it is not known the length of time it will take for the transmitted calibration signal to return to the BTS 100. It is noted that the calibration signal is not constrained to take on specific RACH characteristics, such as, modulation, channel coding, message content, etc.

There is a slight probability that a mobile attempting to access the system over the RACH will do so at the same time slot as the calibration signal is looped back to the BTS by the translating repeater. However, in this situation, the system will behave the same as if the two mobiles attempted to simultaneously access the system. In this case, the mobile will re-attempt system access at a later time. If the mobile corrupts the received looped back calibration signal such that it cannot be used, the system will simply reattempt calibration during the next multiframe.

Once the receive and transmit chain calibration factors are calculated and stored by BTS 100, the angle of arrival for each uplink channel may be calculated and stored. In practice, angle of arrival for translating repeater transmissions relative to the BTS 100 is known (e.g., based on a survey) at the time of installation and does not change over time. Thus, the translating repeater angle of arrival can be used as an absolute reference, permitting mobile user angle of arrivals at the BTS 100 to be made relative to that fixed reference angle.

In a multi-carrier BTS utilizing 12 RF carriers and 8 TDMA time slots, 96 full duplex channels of GSM are available. In this configuration, 96×2 values of calibration factors are stored for each antenna element and its dedicated receive apparatus chain. Thus, for a duplexed system having 96 channels and 4 antennas, 768 calibration factors are stored to support beamforming in the receive direction. After the uplink angle of arrival is determined, the downlink steering angle is determined as the reciprocal direction.

In actual operation, BTS 100 uses the receive chain apparatus calibration factors when an uplink signal is received by antenna elements 210 to determine the angular location of the signal source, such as a mobile user. Various algorithms known in the art permit accurate identification of the mobile's location, allowing the determination of the angle of arrival of the mobile user's signal. Upon receipt of the arriving signal, the digital array processor 160 may be used to determine the angle of arrival of the incoming signal by measuring the signal shifts of the arriving signal after traveling the respective receive apparatus chains of the several antenna elements 210. In this determination, receive apparatus chain calibration factors already determined and stored therein are used to compensate for differences in the various receive apparatus chains.

Using the mobile user's angle of arrival, angular weighting factors can be readily calculated using methods known in the art to narrow the beam to focus to the user's location and to position nulls to steer toward interference sources. Angular weighting factors are combined with respective calibration factors to produce appropriate net weighting factors for application to the signal paths of each receive antenna chain. Appropriate net weighting factors permit pointing a beam towards the mobile user and up to N−1 nulls (N is the number of antenna elements) toward interference sources. Similarly, using the inverse of the angle of arrival for transmitted signals, respective transmit apparatus chain net weighting factors are determined to point a beam towards the mobile user and up to N−1nulls toward interference sources.

Translating repeaters may be used to calibrate the antenna array in either a passive analog loopback repeat function or an active receive/demodulate remodulate/transmit function. In the passive repeat function, downlink signal are simply frequency translated and looped back to BTS 100. In the active receive function, the translating repeater can demodulate the received signal and remodulate (and frequency shift) the received signal for retransmission. The active receive function can be used to send additional information such as RSSI (receive signal strength) of the mobile user to the BTS 100 during calibration.

Transmit calibration factors are preferably constantly updated during system operation because of component drift, principally due to environmental factors. For example, the length of RF cables and jumpers change (and result in corresponding shifts in time delays to traverse) with heating and cooling from the sun, day/night, weather and other environmental factors. Devices such as surface acoustic wave (SAW) filters found in both the BTS upconverter (downlink transmit) and BTS downconverter (uplink receive) as part of broadband digital transceiver 240 circuitry are particularly sensitive to temperature and are known to produce significant changes in signal shift from modest changes in temperature.

Channelizer 150 separates the inputted composite digital signal comprised of all active RF carriers into separate digital signals representing each RF carrier from a composite signal. Using the angle of arrival data determined for mobile users for all active timeslots for each RF carrier in a TDM system, net weighting factors may be determined by the digital array processor 160 and be separately applied to each active timeslot to point a beam towards the mobile user's location and to point one or more nulls at the most intense interference sources.

Turning to the transmit direction, signals output by DSP 170 to the digital array processor 160 are separate digital signals for each active channel (timeslot). Using the reciprocal of the angle of arrival for the received signal, the digital array processor 160 calculates the optimum net weighting factors for the various transmit apparatus chains and places these net weighting factors in each of the channel's transmit signal path at the digital array processor 160 to point the transmitted antenna beam and one or more nulls in the reciprocal of the uplink signal direction.

Assuming full channel use, the digital array processor 160 generally determines optimum net weighting factors for each antenna element 210 for each of the 96 full duplex signals. However, it is often not desirable to beamform the dedicated control channel used as beacons, since such control channels must be generally available throughout a given cell. Consequently, in the absence of major blocking structures, no weighting factors will be applied to BTS 100 transmitted control channels which function as beacons.

Calibration factors and angular weighting factors may be stored in memory locations in the base station digital array processing card 160. These factors are preferably stored separately. Neglecting control channels, for a cellular system having 96 channels and having 4 duplexed transmit/receive antennas elements, the number of memory locations required is 768 (96×2×4) for calibration factors and the same number for separately stored weighting factors. Angular weighting factors must generally be frequently updated since the cellular user may be moving and a variety of interference sources may arise.

This invention could apply to CDMA, GSM or other systems. Additionally, the invention may be practiced with either a broadband BTS or a narrowband BTS. It should be understood that the examples and embodiments described herein are for illustrative purposes only and that various modifications or changes in light thereof will be suggested to persons skilled in the art and are to be included within the spirit and purview of this application. The invention can take many other specific forms without departing from the spirit or essential attributes thereof for an indication of the scope of the invention.

What is claimed is:

1. In a wireless communication system having at least one remote device for communicating with a base transceiver station (BTS) and a plurality of mobile stations, said BTS having an adaptive antenna array including a plurality of antenna elements, a method for determining calibration factors for respective transmit and receive paths associated with each of said antenna elements, comprising the steps of:
transmitting a downlink signal from said BTS to said remote device from each of said antenna elements;
retransmitting from said remote device said downlink signals back to said BTS as at least one uplink signal;
receiving said uplink signal at said BTS, and
determining calibration factors for said respective antenna transmit and receive paths.

2. The method of claim 1, wherein said remote device is a repeater.

3. The method of claim 1, wherein said remote device is a translating repeater.

4. The method of claim 1, further comprising the step of placing said remote device in a loopback mode.

5. The method of claim 4, further comprising the step of demodulating said loopback signal by said translating repeater.

6. The method of claim 1, wherein said BTS transmits said downlink signals from each of said antenna element, one at a time.

7. The method of claim 1, further comprising the step of programming said remote device with a list of calibration frequencies.

8. The method of claim 1, further comprising the step of said BTS providing a list of calibration frequencies to said remote device using a wireless transmission.

9. The method of claim 8, wherein said list of calibration frequencies are transmitted by said BTS with at least one transmission selected from the group consisting of neighbor lists and system information.

10. The method of claim 1, wherein said calibration method is performed without impacting system traffic capacity.

11. The method of claim 10, wherein said communication system is a TDM system and a RACH is used for said uplink signals and a SDCCH for said downlink signals.

12. The method of claim 1, further comprising the step of storing said calibration factors.

13. The method of claim 1, wherein said calibration is performed at a first calibration frequency, further comprising the step repeating said calibration at a calibration frequency other than said first calibration frequency.

14. The method of claim 13, further comprising the step of said BTS commanding said remote device to said frequency other than said first calibration frequency.

15. A self-calibrating communications system not requiring any additional or external equipment for calibration, the system comprising:
a base transceiver station (BTS) having an antenna array with a plurality of antenna elements;
at least one remote device for communicating with a plurality of mobile stations and said BTS, said remote device configured to be operated in a loopback mode, wherein calibration signals transmitted by said BTS are re-transmitted by said remote device back to said BTS during calibration, whereby calibration factors for said respective antenna transmit and receive paths can be determined without the need for any additional or external equipment for calibration.

16. The system of claim 15, wherein said remote device is a repeater.

17. The system of claim 15, wherein said remote device is a translating repeater.

18. The system of claim 15, wherein said remote device includes structure for demodulating said calibration signals transmitted by said BTS.
